(19) United States
(12) Patent Application Publication
(10) Pub. No.: US 2026/0211269 A1
(43) Pub. Date: Jul. 23, 2026

(54) INTEGRATED PHASE MODULATOR

(71) Applicant: OSCPS MOTION SENSING INC., Montreal (CA)

(72) Inventors: Kazem ZANDI, Montreal (CA); Laurie Richard WILLISTON, London (CA); Ramanand TEWARI, Ottawa (CA); Mohammandreza FASIHANIFARD, Montreal (CA); Odile LIBOURIN-LADOUCEUR, Montreal (CA); Rifat NAZNEEN, Montreal (CA)

(21) Appl. No.: 19/450,882

(22) Filed: Jan. 16, 2026

Related U.S. Application Data
(60) Provisional application No. 63/747,217, filed on Jan. 20, 2025.

(51) Int. Cl. G02F 1/01

(52) U.S. Cl. CPC G02F 1/0128; G02F 2201/12; G02F 2203/50

(57) ABSTRACT

An integrated photonic chip including a silicon chip substrate; a plurality of optical components formed on the substrate, the plurality of optical components including at least one waveguide; and at least one pair of stress optic phase modulators connected to the substrate, the plurality of optical components being disposed between the substrate and the at least one pair of stress optic phase modulators. A method for manufacturing an optical apparatus, such as the chip, includes fabricating a photonic chip having at least one waveguide in a lead-free facility; and subsequently fabricating at least one lead zirconium titanate (PZT) electrode in a second facility, the second facility having lead-compatible fabrication capabilities.

### CROSS-REFERENCE

The present application claims priority to U.S. Provisional Patent Application No. 63/747,217, entitled “Integrated Phase Modulator”, filed Jan. 20, 2025, the entirety of which is incorporated by reference herein.

### TECHNICAL FIELD

The present technology generally relates to phase modulators integrated on silicon chip systems.

### BACKGROUND

Low loss photonic waveguides are being developed for implementation in chip-based optical applications, which operate under similar principles to fiber optic gyroscopes, ring laser gyroscopes, and resonant micro-photonic gyroscopes. Chip based photonic waveguides often use a thin SiN layer to define the optical path. These waveguides are often formed with thick oxide layers above and below thin SiN layer to reduce transmission loss to less than 1 dB per meter. The thick oxide is used to transmit the infrared light with lower absorption (lower loss), while the SiN serves to confine the path of optical transmission.

Fabrication of the thick oxide layer can be costly and time-consuming, and alternatives have been sought. While a thinner oxide layer would reduce cost and fabrication time, the thinner layer may also lead to loss at the top and bottom surfaces of the waveguide by scattering or absorption should the light reach any attenuating material, which could include silicon, any metal or dielectric with higher index of refraction than SiO₂, or contaminants such as particles or adsorbed hydrocarbons on the oxide surface.

On-chip optical systems, such as the above-mentioned gyroscopes as well as planar optical circuits (PLC), generally also require a switching element to control light therethrough. Phase modulators are often implemented for the switching, as well as polarization control. One type commonly used is a thermo-optic modulator which affects light phase by temperature-based manipulation of the refractive index. The speed of switching is limited, however, by the speed of heating and cooling of the low-thermal conductive materials. Further, thermo-optic modulators generally have high energy consumption.

There thus remains a desire for improvements in this area.

### SUMMARY

The inventors of the present technology have developed improvements in this area, specifically with the development of a phase modulator arrangement for optical circuitry or photonic integrated chips (PIC). The proposed phase modulator is low loss, enabling an increased achievable phase shift. The modulator arrangement, described in more detail below, has a relatively reduced device area and reduced operating voltage (i.e. lower power consumption) than comparable modulators.

Phase modulators, when implemented as discrete devices, may induce significant optical losses due to reflected and scattered light when fabricated from heterogeneous materials, especially when connecting to a photonic waveguide. To avoid these losses, phase modulators can be integrated into a Silicon Nitride (SiN) platform to avoid transitions between dissimilar materials, changes in refractive index, and the need for optical couplers, all of which can increase loss. Integrated phase modulators in the SiN platform include thermal phase modulators, where heaters are applied on top of the SiN waveguide that serve to change the temperature, and thus the refractive index of the waveguide, which in turn leads to the phase shift and modulation of the transmitted light.

However, thermal phase modulator devices are too slow for many optical applications, including for instance gyroscopes. Titanium in-diffused Lithium Niobate single crystal phase modulators as the discrete devices are state of the art but are too large in dimension and require high operating voltages for a compact chip-based optical device. Such modulators are also very expensive and require coupling to photonic chips using optical fiber or edge (butt) coupling, both creating significant optical losses.

Thin Film Lithium Niobate (TFLN) based phase shifters and phase modulators are also under development by various foundries but also suffer from important deficiencies. The TFLN fabrication is only available in fabrication facilities using 4-inch wafers, which are incompatible with commonly-used 8-inch photonic wafers. Such devices thus are required to be coupled to SiN gyroscope sensors or similar photonic chip devices within either spiral loops or ring resonators using optical fibers or photonic wire bonding (PWB). This arrangement similarly comes with considerable insertion loss. It is further noted that the cost of single crystal or epitaxial wafers of Lithium Niobate on silicon is prohibitively high.

The present technology proposes the use of stress-based integrated phase modulators, including lead zirconium titanate (PZT). Some work has been done with PZT layers placed above and around a SiN waveguide to create a stress gradient that similarly affects the refractive index and consequently the phase at the output of the SiN waveguide. This requires the PZT to be in close proximity to the waveguide to achieve sufficient stress levels for phase shift and phase modulation. Such embodiments use dual SiN waveguides placed vertically one over the other. with a thin oxide layer therebetween, to constrain the light between the waveguides and achieve low loss.

While providing the reactivity necessary and avoiding insertion losses from coupling, dual SiN waveguides based PZT modulators unfortunately require more processing steps and thus increase time and cost of fabrication. To have fewer processing steps, use of single SiN waveguide based PZT modulators could be preferred. However, single SiN waveguides are thinner, which in turn could lead to more waveguide mode spreading into the oxide in the vertical direction. This vertical spreading is not compatible with the stress-based phase modulator approach currently employed in the art, as light would reach the metal electrodes or PZT material used in the piezoelectric element formation and be absorbed or scattered. Single SiN waveguides would further be too lossy to allow placement of the PZT modulators directly thereover. Reflection from a high index material also induces a 180-degree phase shift in the light, which also adversely affects the optical output.

As will be described in more detail, the present arrangement removes all PZT and metal from the immediate proximity to the top of the waveguide to ensure that any light coupled through the waveguide that reaches the surface of the oxide does not get attenuated due to the presence of PZT and metal electrodes. Additionally, the proposed solution uses the enhanced stress gradient present at the edge of the PZT material to achieve higher stress levels. By using two PZT electrodes, one on either lateral side of the waveguide and distanced vertically therefrom, it is possible to adjust spacing to maximize stress level in the waveguide itself.

The present design differs from prior art because it can be used in a single stripe waveguide with width 2.8 μm and thickness 100 nm, that is identical to that used in low loss (1 dB/meter) ring resonator formation. Aside from the addition of PZT and metal electrodes, the present arrangements further does not require any modifications to the optimal low-loss process. The process has been developed that allows for these supplementary layers, forming the phase modulators, to be added on after the photonic chip has been completed and before dicing, to allow for flexibility of choice of a fabrication facility. Very few production facilities use PZT in the process line or will even allow it into their facilities, due to the risks of contamination from the lead present in PZT deposition. The new arrangement provided herein allows the photonic integrated chip (PIC) to be nearly completed in any fabrication facility, with the PZT material being added and shaped as a secondary process, in a second facility if necessary.

The present technology has at least some of the following technical benefits or advantages achieved by its novel technical features. The newly presented arrangement permits full integration of an on-chip phase modulator design with processes compatible with ultra-low loss photonic processes for SiN waveguide width of 2.8 μm and thickness of 100 nm. This eliminates any alignment issues and loss associated with connecting a phase modulator to the photonic ring, for instance in a gyroscope. PZT components can be added subsequent to PIC processing but prior to dicing, which removes limitations on fab facilities and reduces cost. Lateral separation of PZT from waveguide can maintain low loss while allowing efficient coupling of stress to the waveguide, maximizing the achievable phase shift and reducing device area. Reduced operating voltage compatible with lower power consumption by use of both sides of same PZT electrode by looping waveguide between an array of PZT electrodes allows for compact design and increasing phase shift attainable at low operating voltage.

According to one aspect of the present technology, there is provided an integrated photonic chip including a silicon chip substrate; a plurality of optical components formed on the substrate; and at least one pair of stress optic phase modulators connected to the substrate, the plurality of optical components being disposed between the substrate and the at least one pair of stress optic phase modulators.

In some embodiments, each modulator of the at least one pair of stress optic phase modulators is formed from a lead zirconium titanate (PZT) electrode.

In some embodiments, the plurality of optical components includes at least one waveguide.

In some embodiments, the at least one pair of stress optic phase modulators includes at least one first lead zirconium titanate (PZT) electrode; and at least one second PZT electrode spaced from the at least one first PZT electrode.

In some embodiments, the plurality of optical components includes at least one waveguide; and the at least one waveguide is disposed laterally between an in-plane projection of the at least one first PZT electrode and the at least one second PZT electrode.

In some embodiments, the chip further includes at least one third PZT electrode disposed in a same plane as the at least one first PZT electrode and at least one second PZT electrode; and the at least one waveguide extends between each of the PZT electrodes by looping back and forth to increase interaction areas between the plurality of PZT electrodes and the at least one waveguide.

In some embodiments, the plurality of optical elements are formed on top of the substrate; and the at least one pair of stress optic phase modulators are formed on a top layer covering the plurality of optical elements.

In some embodiments, the plurality of optical elements are formed in a first fabrication facility; and the at least one pair of stress optic phase modulators are formed in a second fabrication facility, distinct from the first fabrication facility.

In some embodiments, the first facility is a lead-free fabrication facility; and the at least one pair of stress optic phase modulators are formed from PZT, the second facility including lead-based fabrication modalities.

In some embodiments, the at least one pair of stress optic phase modulators are not disposed directly over the at least one waveguide.

In some embodiments, a stress distribution function within at least one of the plurality of optical components depends on a lateral separation between the at least one pair of stress optical phase modulators.

In some embodiments, the chip further includes a top oxide layer disposed between the plurality of optical components and the at least one pair of stress optical phase modulators; and a stress distribution function within at least one of the plurality of optical components depends on a thickness of the top oxide layer.

According to another aspect of the present technology, there is provided a method for fabricating a photonic integrated chip with stress optic phase modulator. The method includes forming a first silicon oxide layer on a silicon wafer; forming at least one optical component of silicon nitride on the first silicon oxide layer; forming a second silicon oxide layer over the at least one optical component; and forming at least one lead zirconium titanate (PZT) electrode over the second silicon oxide layer, the at least one PZT electrode being shaped and configured to form a phase modulator, the at least one PZT electrode inducing a phase shift in light in the at least one optical component during use.

In some embodiments, the method further includes forming metal layers above and below the at least one PZT electrode. In some cases, the metal layers could be formed on lateral sides of the PZT material, such that the electrode assembly is contained in a same vertical layer.

According to yet another aspect of the present technology, there is provided a method for manufacturing an optical apparatus. The method includes fabricating a photonic chip having at least one waveguide in a lead-free facility; and fabricating at least one lead zirconium titanate (PZT) electrode in a second facility, the second facility having lead-compatible fabrication capabilities.

Implementations of the present disclosure each have at least one of the above-mentioned objects and/or aspects, but do not necessarily have all of them. It should be understood that some aspects of the present disclosure that have resulted from attempting to attain the above-mentioned object may not satisfy this object and/or may satisfy other objects not specifically recited herein.

Additional and/or alternative features, aspects and advantages of implementations of the present disclosure will become apparent from the following description, the accompanying drawings and the appended claims.

### BRIEF DESCRIPTION OF THE DRAWINGS

Further features and advantages of the present disclosure will become apparent from the following detailed description, taken in combination with the appended drawings, in which:

FIG. 1 depicts an example simulated stress gradient in units of N/m² of a PZT component on 7 μm top SiO₂ cladding exhibiting highest stress at the edge of PZT with one PZT strip waveguide of 10 μm width placed beside the single stripe SiN waveguide of width 2.8 μm and thickness 100 nm with a horizontal distance of 3.6 μm, the stress being symmetric on both sides of the PZT element with highest stress gradient at PZT edge.

FIG. 2A depicts a simulated stress gradient in units of N/m² of two PZT electrodes with width of 25 μm displaced laterally above a single stripe SiN waveguide having a width of 2.8 μm and thickness of 100 nm with bottom and top oxide thicknesses of 8 μm and 6 μm respectively, with gap of 10 μm of PZT, the stress concentrated at the edge of the two PZT elements having a combined effect within the gap beneficial within this region.

FIG. 2B depicts simulated results showing tensile stress vs. top oxide thickness for a top oxide thickness of 6 μm.

FIG. 2C depicts simulated results showing effective index change (Δ_{neff}) of the TE fundamental mode vs. applied voltage for a top oxide thickness of 6 μm.

FIG. 2D depicts phase shift vs. applied voltage for a top oxide thickness of 6 μm.

FIG. 3A depicts a simulated stress gradient in units of N/m² of two PZT electrodes with width of 25 μm displaced laterally above a single stripe SiN waveguide having a width of 2.8 μm and thickness of 100 nm with bottom and top oxide thicknesses of 8 μm and 3 μm respectively, with reduced gap of 3 μm of PZT.

FIGS. 3B and 3C depict the simulated TE fundamental mode in a lateral direction for a top oxide thickness of 3 μm.

FIGS. 3D and 3E depict the simulated TE fundamental mode in vertical direction for top oxide thickness of 3 μm.

FIG. 3F depicts the simulated results showing effective index change (Δ_{neff}) of the TE fundamental mode vs. applied voltage for top oxide thickness of 3 μm.

FIG. 3G depicts the simulated results showing effective mode index (neff) of the TE fundamental mode vs. applied voltage for top oxide thickness of 3 μm.

FIG. 3H depicts phase shift vs. applied voltage for top oxide thickness of 3 μm.

FIG. 4 is a schematic drawing of PZT phase modulators according to one non-limiting embodiment of the present technology and waveguide routing to achieve compact routing of waveguide around both sides of PZT elements to increase length of stressed waveguide element and thus to achieve lower actuation voltage.

FIGS. 5 to 10 illustrate one non-limiting embodiment of a fabrication process flow of the silicon nitride based PZT modulator with silicon nitride width of 2.8 μm and thickness of 100 nm, with PZT and metal electrodes having a gap at the top such that the vertical evanescent field into the oxide from the silicon nitride waveguide does not interact with the PZT and the metal electrodes.

FIG. 11 illustrates a simplified process flow for PZT compatible with PIC gyroscope process fabrication.

It is noted that the Figures may not be drawn to scale. It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims.

### DETAILED DESCRIPTION

The instant disclosure is directed to devices and methods addressing the deficiencies of the current state of the art. To this end, the instant disclosure describes phase modulator design allowing for on-chip fabrication on low loss photonic integrated circuit chips suitable for gyroscope or other photonic applications with the addition of a backend piezoelectric material and electrodes.

The objective of the current technology is to create a cost effective, compact, and low loss photonic gyroscope chip with a fully integrated silicon nitrate (SiN) based lead zirconium titanate (PZT) phase modulator which can be fabricated on a chip with the SiN based photonic sensing spiral loops or ring resonators with a process compatible with the low loss (less than 1 dB/meter) process. This reduces additional process costs and eliminates any assembly, alignment and coupling errors between the phase modulator and the photonic gyroscope sensor chip. In at least some implementations of the PZT phase modulators, it is contemplated that the modulators could be integrated into other photonic integrated chip components or devices.

The design is intended to deliver π phase shift within a standard reticle size (nominally 22 mm×22 mm) at an ideal operating voltage of less than 5V. Lead zirconium titanate has been chosen as the piezoelectric material as it has advantageous stress properties, but the design has been selected to allow for other materials to be used such as aluminum nitride doped, which can be used where lead-based processing is not an option. In this case, the phase modulator length simply has to be increased to account for the lower stress gradient caused by the lower piezoelectric coefficient of aluminum nitride.

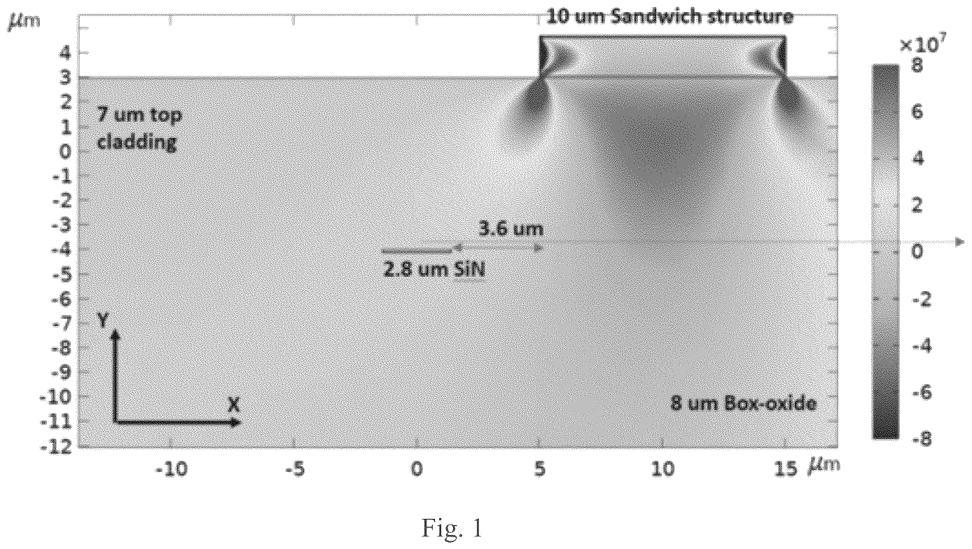

PZT is a piezoelectric material with a high piezoelectric constant which allows for the application of stress gradient to an attached material with applied voltage. By deposition of an electrode formed of PZT on silicon dioxide, a stress gradient similar to that shown in FIG. 1 can be applied. As used herein, a PZT electrode refers to an electrode formed from a layer of PZT material with at least one metal layer in contact with the PZT material. The scale shown on the right has the units N/m² (note the ×10⁷ multiplier at the top). Placing the PZT electrode above the waveguide (not shown) can be seen to cause a compressive stress on the waveguide, whereas as shown, a tensile stress is applied when placed adjacent to the waveguide. The PZT embodiment shows vertical electrode stacking for PZT element but does not preclude horizontal placement of the electrodes which could, for example, reduce the number of process steps

FIG. 1 also illustrates a silicon nitride waveguide with width of 2.8 μm and thickness of 100 nm (not shown in the figure) with bottom oxide thickness of 8 μm and top oxide cladding thickness of 7 μm. The edge of the silicon nitride waveguide is 3.6 μm away from the edge of the PZT electrode with width of 10 μm. The 8 μm bottom oxide thickness is chosen so that the evanescent field of the fundamental mode of the silicon nitride waveguide does not interact with the silicon substrate so as to avoid any propagation losses. The directions X and Y denote the directions of width and thickness, respectively and the direction Z (not shown in the figure) is the direction of the propagation of the fundamental modal field. The top oxide cladding thickness of 7 μm is chosen to be such that only a small amount of evanescent modal field interacts with the PZT electrodes.

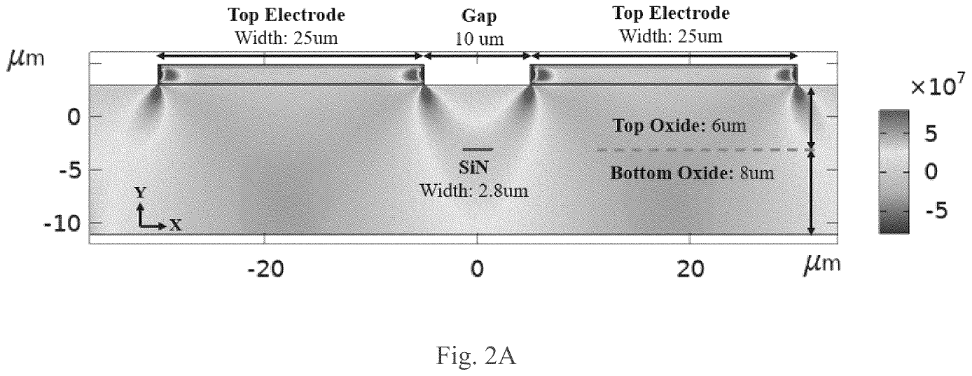

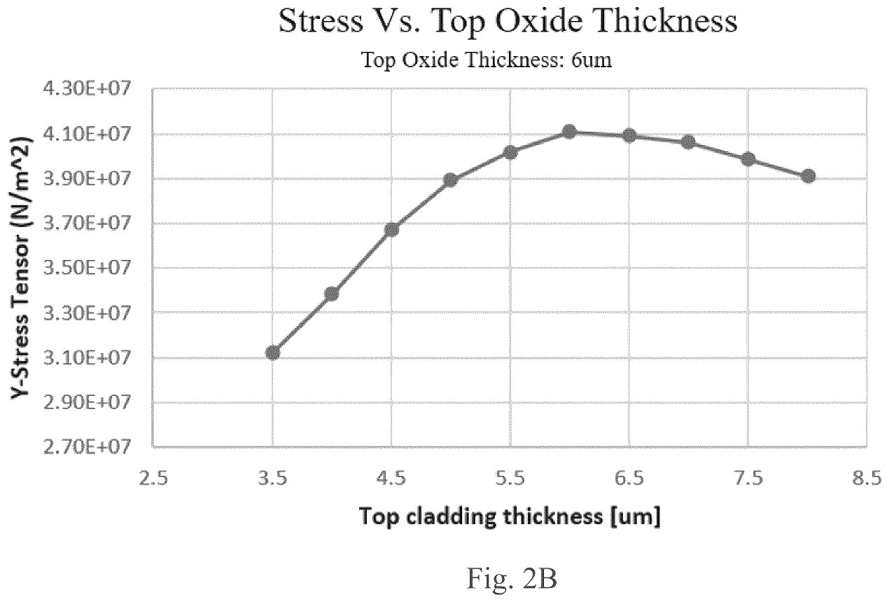

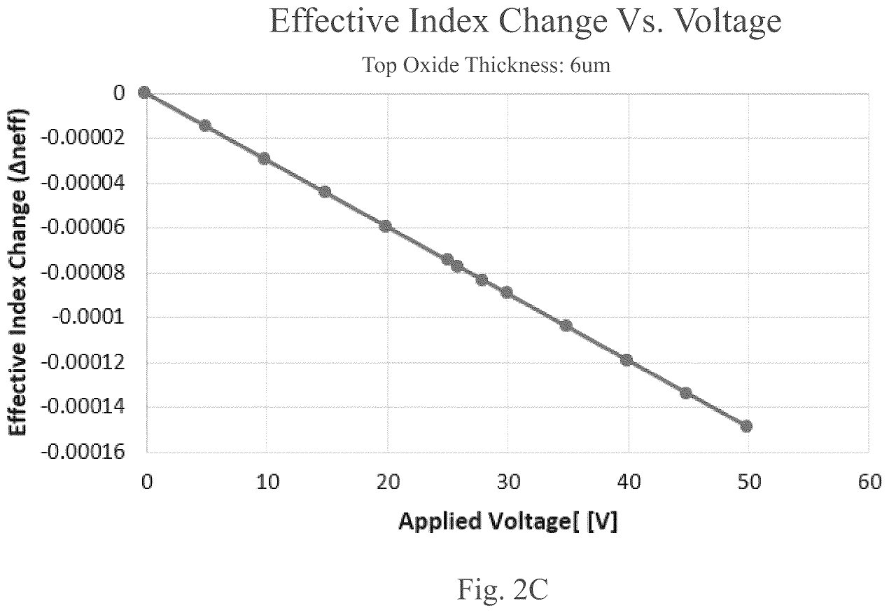

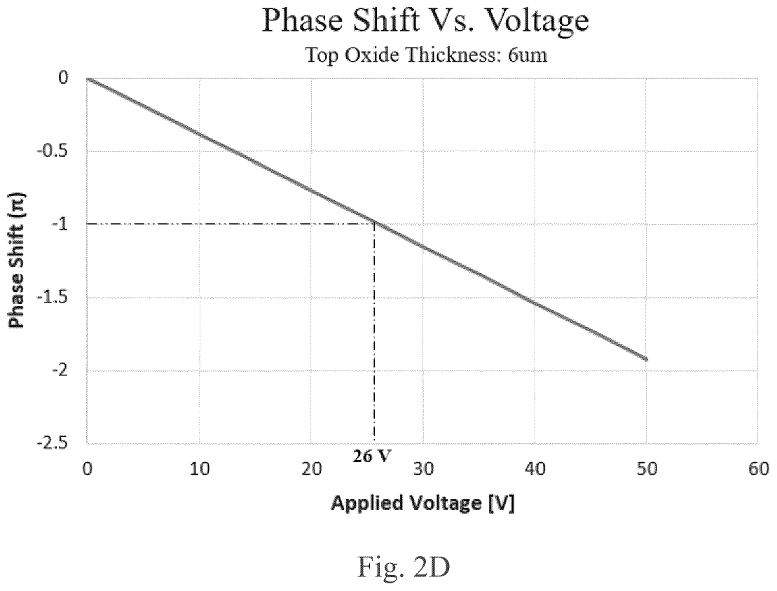

Advantages of the placement shown are that the PZT acts as a tensile stress riser, with wider PZT electrodes building up more tensile stress focused on the edge of the electrode. As seen in FIG. 2A, the effect is additive wherein two electrodes can apply complementary tensile stress levels that increase the tensile stress within the waveguide. With dielectric materials such as SiO₂ and Si3N4, changes in tensile stress cause a proportional change in refractive index in the material, which is the source of phase change in such devices.

Recent advancements in low loss spirals loops and resonant rings for gyroscope applications require losses less than 1 dB/meter and one approach is to reduce the waveguide thickness, which forces the waveguide mode to expand into the oxide cladding, which has lower loss. Typically, this requires an associated increase in cladding thickness as the light that reaches the surface of the cladding has the potential to be scattered or absorbed by any adsorbed surface contaminant. Any foreign material with refractive index greater than silicon dioxide or any inhomogeneity could cause loss. This also favors lateral placement of the PZT electrodes away from this critical region above the waveguide, to avoid loss.

There may also be an advantage from a manufacturing perspective to reduce surface cladding thickness to reduce cost. It is difficult to deposit optically transparent films (at 1550 nm wavelength) to a thickness of more than 3 μm without annealing the film to drive out adventitious hydrogen. Thicker oxide films more than 3 μm require repetitive cycles of deposition and annealing to achieve thick, low-loss films. Commercial fabrication facilities tend to commonly use 8 μm oxide films for a waveguide with width 2.8 μm and thickness 100 nm. Lower losses have been achieved by using much thinner thicknesses of silicon nitride going down to 40 nm. However, for thinner waveguide structures of 40 nm thick SiN waveguide, the mode of light transmission moves deeper into the cladding above and below the waveguide requiring the need for 15 μm thick oxide to avoid any losses due to contamination at the oxide-air interface or any absorbent materials. Thinner oxide films may be used if precautions are taken to prevent any contamination from coming in contact with the thinner oxide surface. In Reference 3, this has been done by hermetic packaging of the chip, which adds significant cost offsetting some of the savings achieved by using thinner cladding.

It should also be noted that the use of extremely thick oxide layers may cause associated stress buildup with thickness that can cause warping of the silicon wafer substrate. This may prohibit subsequent processing requiring photolithography, either contact or direct writing, and may be undesirable. Attempts to reduce warping such as complicated thinning of cladding outside of active areas can further add to cost.

FIG. 2A shows a simulation illustrating the effect of lateral displacement of the PZT electrodes with spacing of 10 μm and width of 25 μm to either side of the SiN waveguide with width of 2.8 μm and thickness of 100 nm. This arrangement and spacing creates a free region above the waveguide to ensure low loss, while focusing the tensile stress gradient to maximal effect on the waveguide itself. Through a variety of simulations, it can be illustrated how varying cladding thickness around the illustrated thickness value can decrease the effective stress level in the waveguide. It should thus be noted that the optimal stress level is geometry dependent and must be calculated for the particular embodiment. The simulations illustrated in FIG. 2B for stress versus top oxide thickness show that as the top oxide thickness increases, the tensile stress increases and achieves a maximum around 6 μm of top oxide thickness. The simulated graph effective index change versus applied voltage in FIG. 2C shows that there is a decrease in the effective index with the increase in the applied voltage. As shown in FIG. 2D, this change in effective index leads to a π phase shift (180°) at an applied voltage of 26V.

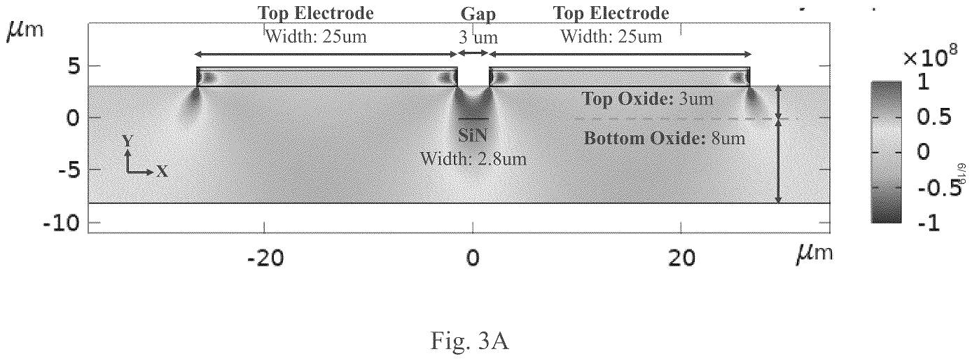

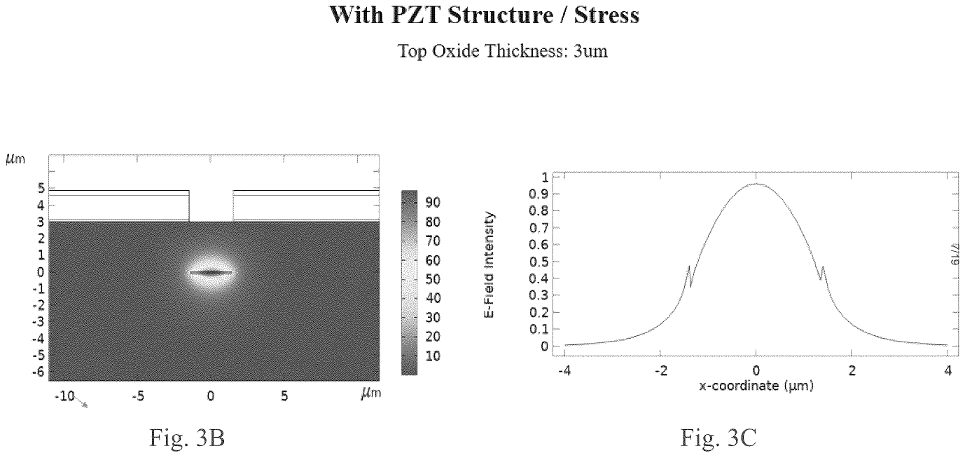

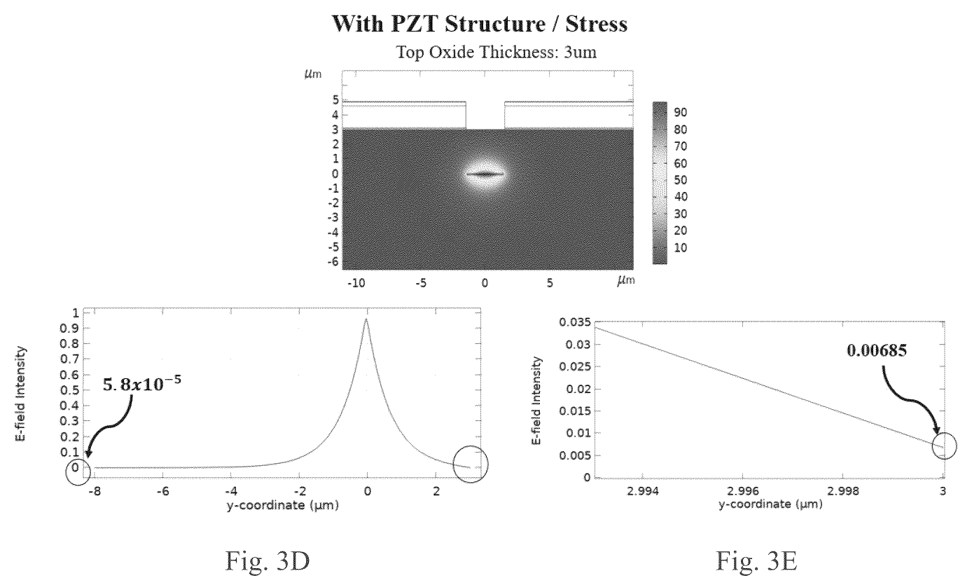

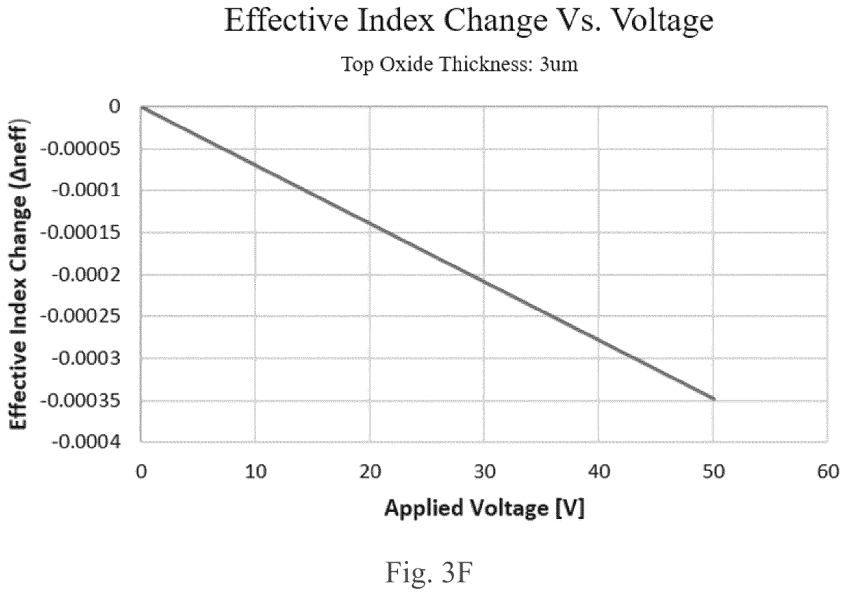

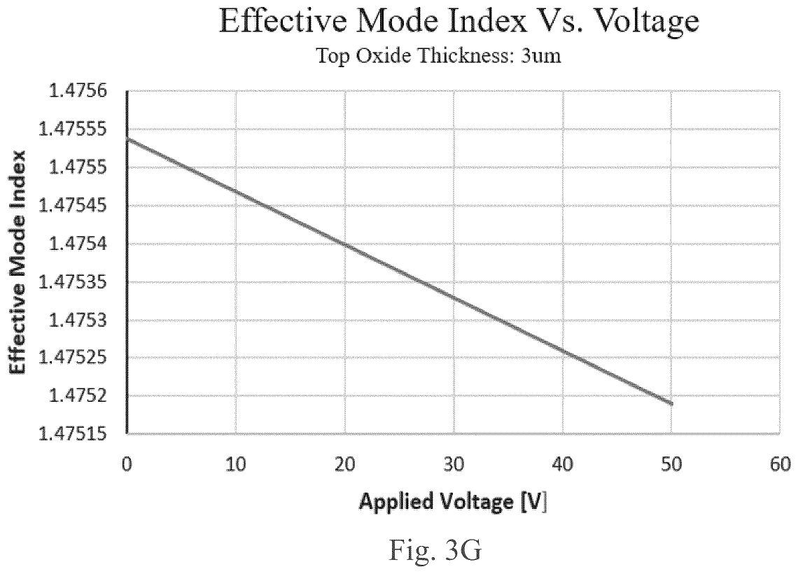

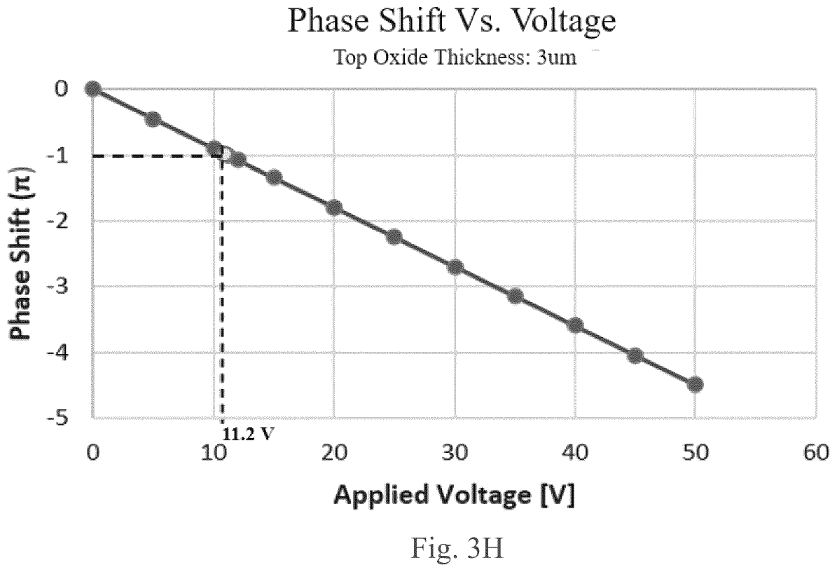

In FIG. 3A, spacing between the PZT elements has been reduced to a minimum value of 3 μm and the top oxide thickness reduced to 3 μm, which would be ideal from a process point of view with only one time deposition of cladding layer is required. The tensile stress is centered at the SiN waveguide and the calculated phase shift (see FIG. 3H), shows that a voltage as low as 11.2V/cm of waveguide could be used to actuate the device. This is used as a figure of merit and therefore to achieve the operating voltage of 5V for π phase shift the SiN waveguide length as well as corresponding PZT length would be around 2.24 cm. It should be mentioned that for low-cost electronic components to be used in gyroscope applications, the ideal operating voltage should be around 5V.

The FIGS. 3F and 3G show the intermediate simulations of effective index change vs. applied voltage and effective mode index vs. applied voltage, respectively for the 3 μm top oxide of FIG. 3A. As can be seen from FIG. 3F, that the tensile stress increases as the applied voltage increases leading to more phase shift as shown in FIG. 3H. As shown in FIG. 3G, the increase in applied voltage also leads to decrease in effective mode index of the fundamental mode that eventually leads to more evanescent field leaking towards a PZT electrode or more overlap between fundamental mode and tensile stress leading to increased phase shift as evident from FIG. 3H as well. FIGS. 3B and 3C show the TE mode E-field intensity profile in lateral direction for 3 μm top oxide thickness. As can be seen from FIG. 3C, the TE mode E-field intensity reaches zero after a lateral distance of 4 μm. FIGS. 3D and 3E show the TE mode E-field intensity profile in vertical direction for the same 3 μm top oxide thickness. As can be seen from FIG. 3D the TE mode E-field intensity reaches to almost 50 dB down at 8 μm bottom oxide thickness or at the bottom oxide and silicon buffer interface to ensure that the TE mode E-field intensity does not attenuate significantly. As can also be seen from FIG. 3E, the TE mode E-field intensity reaches about 0.00685 at the boundary of 3 μm top oxide and the PZT electrode, which results in overlap of tensile stress and TE mode field giving the π phase shift at an applied voltage of 11.2V.

TABLE 1

| | Top oxide | Distance | PZT | PZT | |
|---|---|---|---|---|---|
| | thickness | between | width | thickness | Vπ for |
| | (μm) | two PZTs | (μm) | (μm) | L = 1 cm |
| Design 1 | 8 | 22.8 | 25 | 1.5 | 65 V |
| Design 2 | 8 | 20 | 25 | 1.5 | 50 V |
| Design 3 | 8 | 10 | 25 | 1.5 | 35 V |
| Design 4 | 6 | 10 | 10 | 2 | 38 V |
| | | | | | (L = 3 cm) |
| Design 5 | 6 | 10 | 25 | 1.5 | 26 V |
| Design 6 | 3 | 3 | 25 | 1.5 | 11.2 V |
| Design 7 | 8 | 22.8 | 100 | 1.5 | 60 V |
| Design 8 | 8 | 15 | 25 | 1.5 | 45 V |

In Table 1, a subset of simulated results is shown, with the design in FIG. 3A highlighted as Design 6, and with associated low voltage operation. Note that operating voltages are all above 5V for π-phase shift, but this can be corrected by increased SiN waveguide length. Since normal reticle size for photonic integrated circuit fabrication is 22 mm×22 mm, this would likely limit the ability to reduce operating voltage.

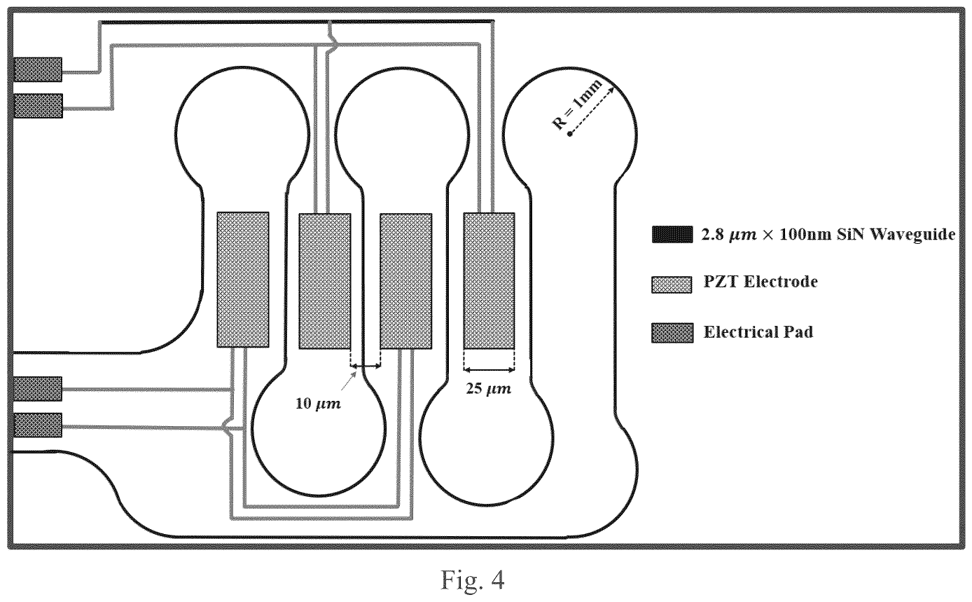

FIG. 4 shows a concept whereby the waveguide can be routed around both sides of a PZT electrode and additional electrodes around the looped waveguide can increase the achievable phase shift. Note that each loop can increase bend loss, so an attempt is made to keep loop diameter above 1 mm for SiN waveguide of width 2.8 μm and thickness of 100 nm, which yields an acceptable bend loss value.

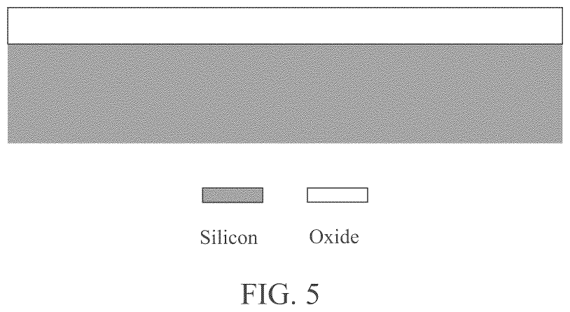

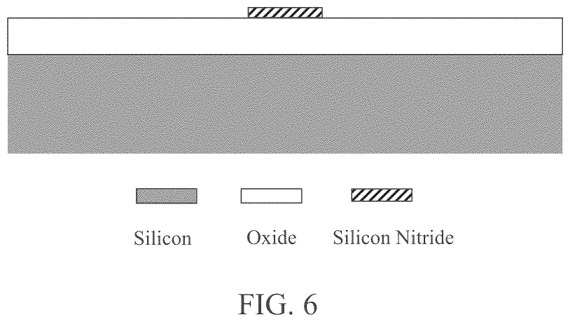

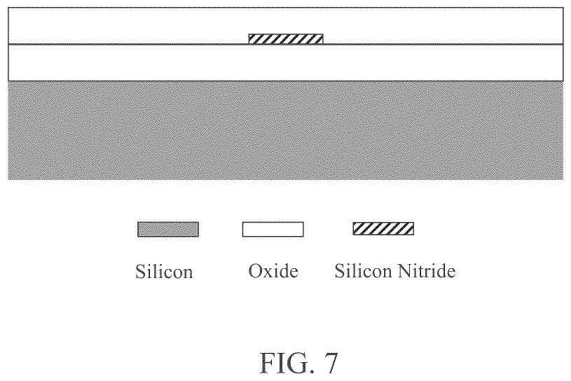

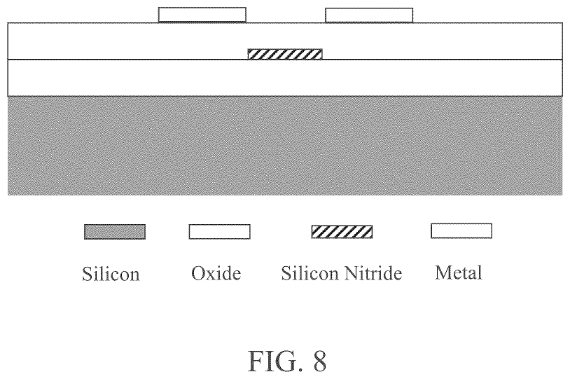

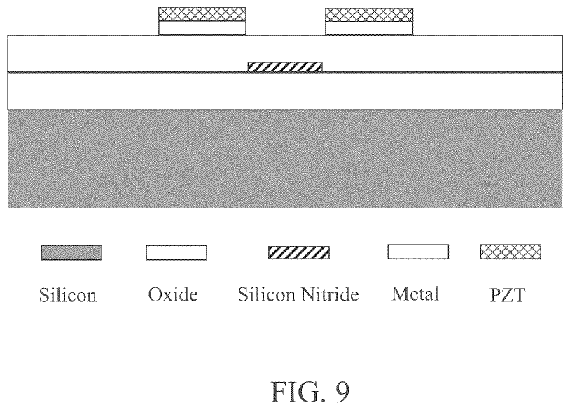

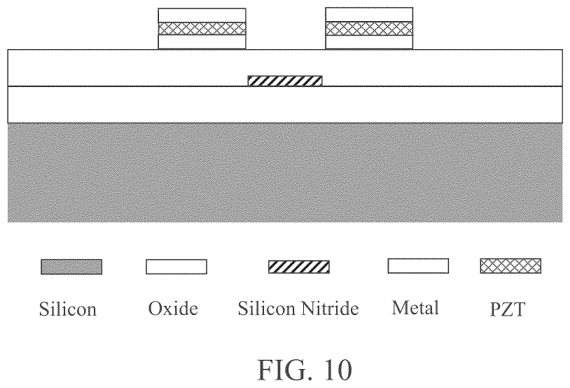

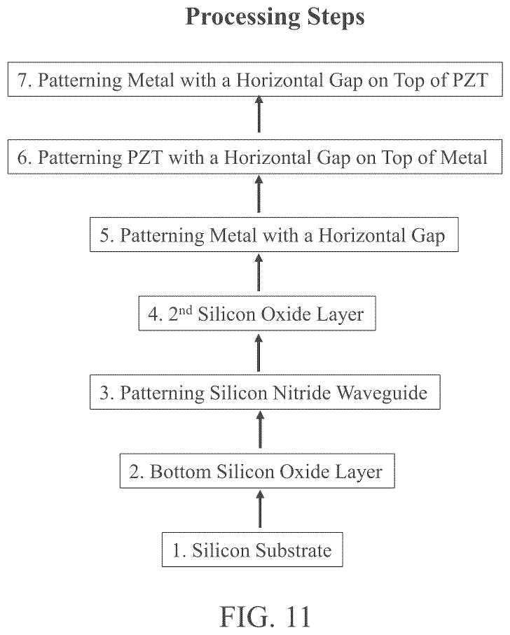

FIGS. 5 to 10 illustrate one non-limiting embodiment of a fabrication process flow of the silicon nitride based PZT modulator with silicon nitride width of 2.8 μm and thickness of 100 nm, where PZT and metal electrodes have a gap at the top so that the vertical evanescent field into the top oxide from the silicon nitride waveguide does not interact with the PZT and the metal electrodes. FIG. 5 illustrates thermal oxidation of silicon wafer to form base SiO2 layer. FIG. 6 illustrates deposition and patterning of a SiN waveguide. FIG. 7 illustrates deposition of a top oxide layer. FIG. 8 illustrates deposition and patterning of bottom metal electrode. FIG. 9 illustrates deposition and patterning of PZT on top of metal FIG. 10 illustrates deposition and patterning of metal on top of PZT. FIG. 11 illustrates this simplified process flow for PZT compatible phase modulator fabrication for a PIC gyroscope in a flowchart.

It should be understood that chemical deposition, as described herein, of various layers on the substrate and other layers provides immovable attachment of the layers to the substrate and the other layers, respectively. The resulting immovable attachment of the ring resonator and its elements to the waveguide and its elements significantly reduces noise that may be caused by changes in the environment, such as, for example, vibrations or temperature change. Such reduction of noise allows for increase of Q-factor in the gyroscope chips as described herein.

Modifications and improvements to the above-described embodiments of the present technology may become apparent to those skilled in the art. The foregoing description is intended to be exemplary rather than limiting.

1. An integrated photonic chip comprising:
a silicon chip substrate;
a plurality of optical components formed on the substrate, the plurality of optical components including at least one waveguide; and
at least one pair of stress optic phase modulators connected to the substrate, the plurality of optical components being disposed between the substrate and the at least one pair of stress optic phase modulators.

2. The chip of claim 1, wherein each modulator of the at least one pair of stress optic phase modulators is formed from a lead zirconium titanate (PZT) electrode.

3. The chip of claim 2, wherein the plurality of optical components includes at least one waveguide.

4. The chip of claim 1, wherein the at least one pair of stress optic phase modulators includes:
at least one first lead zirconium titanate (PZT) electrode; and
at least one second PZT electrode spaced from the at least one first PZT electrode.

5. The chip of claim 4, wherein:
the at least one waveguide is disposed laterally between an in-plane projection of the at least one first PZT electrode and the at least one second PZT electrode.

6. The chip of claim 5, further comprising:
at least one third PZT electrode disposed in a same plane as the at least one first PZT electrode and at least one second PZT electrode; and
wherein the at least one waveguide extends between each of the PZT electrodes by looping back and forth to increase interaction areas between each of PZT electrodes and the at least one waveguide.

7. The chip of claim 1, wherein:
the plurality of optical components are formed on top of the substrate; and
the at least one pair of stress optic phase modulators are formed on a top layer covering the plurality of optical components.

8. The chip of claim 7, wherein:
the plurality of optical components are formed in a first fabrication facility; and
the at least one pair of stress optic phase modulators are formed in a second fabrication facility, distinct from the first fabrication facility.

9. The chip of claim 8, wherein:
the first facility is a lead-free fabrication facility; and
the at least one pair of stress optic phase modulators are formed from PZT, the second facility including lead-based fabrication modalities.

10. The chip of claim 1, wherein the at least one pair of stress optic phase modulators are not disposed directly over the at least one waveguide.

11. The chip of claim 1, wherein a stress distribution function within at least one of the plurality of optical components depends on a lateral separation between the at least one pair of stress optical phase modulators.

12. The chip of claim 1, further comprising a top oxide layer disposed between the plurality of optical components and the at least one pair of stress optical phase modulators; and
wherein a stress distribution function within at least one of the plurality of optical components depends on a thickness of the top oxide layer.

13. A method for fabricating a photonic integrated chip with stress optic phase modulator, the method comprising:
forming a first silicon oxide layer on a silicon wafer;
forming at least one optical component of silicon nitride on the first silicon oxide layer;
forming a second silicon oxide layer over the at least one optical component; and
forming at least one lead zirconium titanate (PZT) electrode over the second silicon oxide layer, the at least one PZT electrode being shaped and configured to form a phase modulator, the at least one PZT electrode inducing a phase shift in light in the at least one optical component during use.

14. The method of claim 13, further comprising forming metal layers above and below the at least one PZT electrode.

15. A method for manufacturing an optical apparatus, the method comprising:
fabricating a photonic chip having at least one waveguide in a lead-free facility; and
fabricating at least one lead zirconium titanate (PZT) electrode in a second facility, the second facility having lead-compatible fabrication capabilities.
